(19) United States
(12) Patent Application Publication
(10) Pub. No.: US 2026/0003152 A1
(43) Pub. Date: Jan. 1, 2026

(54) PASSIVE ACTUATION TO CORRECT FOR ERROR CONTRIBUTORS IN AN ALIGNMENT-CRITICAL SYSTEM THROUGH USE OF A SAMPLE MATERIAL

(71) Applicant: Eagle Technology LLC, Melbourne, FL (US)

(72) Inventor: Steven Sutton, Rochester, NY (US)

(21) Appl. No.: 18/758,317

(22) Filed: Jun. 28, 2024

(51) Int. Cl. G02B 7/00; G01S 7/481

(52) U.S. Cl. CPC G02B 7/003; G01S 7/481

(57) ABSTRACT

Systems and methods for operating a system. The systems comprise: at least two optical components; a support structure configured to structurally support the at least two optical components in a spaced apart arrangement (the support structure comprising a material having at least one geometric dimension that varies throughout a lifespan of the system); and a displacement compensator disposed between the support structure and at least one optical component of the at least two optical components, and configured to passively and/or actively maintain an alignment of the at least two optical components, despite variations of the at least one geometric dimension of the support structure; wherein the displacement compensator is configured to apply pushing forces or pulling forces on the optical component(s) responsive to physical changes of a material sample formed of a same material as the support structure.

### BACKGROUND

### Description of the Related Art

Alignment-critical systems (e.g., Electro-optical (EO) systems) are carefully constructed and are subject to error in performance due to the movement of their components after assembly. This movement can come from several sources, for example: thermal changes growing/shrinking hardware, composites “drying out” (hygroscopic shrinkage), material-related temporal growth.

### SUMMARY

The present disclosure concerns an alignment-critical system. The alignment-critical system comprises: at least two optical components; a support structure configured to structurally support the at least two optical components in a spaced apart arrangement (the support structure comprising a material having at least one geometric dimension that varies throughout the lifespan the alignment-critical system); and a displacement compensator disposed between the support structure and at least one optical component of the at least two optical components, and configured to passively and mechanically maintain an alignment of the alignment-critical system, despite variations of the at least one geometric dimension of the support structure; wherein the displacement compensator is configured to apply pushing forces or pulling forces on the optical component(s) responsive to physical changes of a material sample formed of a same material as the support structure.

The present disclosure also concerns implementing systems and methods for operating an alignment-critical system. The method comprises: using a support structure to structurally support at least two optical components in a spaced apart arrangement (wherein the support structure comprises a material having at least one geometric dimension that varies throughout the lifespan of the alignment-critical system); applying pushing forces or pulling forces by a displacement compensator on at least one optical component of the at least two optical components responsive to physical changes of a material sample of the displacement compensator that is formed of a same material as the support structure; and using the pushing forces or pulling forces to maintain an alignment of the at least two optical components despite variations of the at least one geometric dimension of the support structure. The displacement compensator is disposed between the support structure and at least one optical component of the at least two optical components.

### BRIEF DESCRIPTION OF THE DRAWINGS

The present solution will be described with reference to the following drawing figures, in which like numerals represent like items throughout the figures.

FIGS. 1A-1B (collectively referred to herein as FIG. 1) provides illustrations of an alignment-critical system implementing the present solution.

FIGS. 2A-2C (collectively referred to herein as FIG. 2) provide illustrations that are useful for understanding optical component architectures in which distances between optical components are subject to change.

FIGS. 3A-3C (collectively referred to herein as FIG. 3) provide illustrations that are useful for understanding an illustrative architecture configured to compensate for changes in distances between optical components.

FIG. 4 provides an illustration of another architecture of the present solution that is configured to compensate for changes in distances between optical components.

FIGS. 5A-5B (collectively referred to as “FIG. 5”) provides a perspective view of an illustrative displacement compensator.

FIG. 6 provides a top or bottom view of the displacement compensator shown in FIG. 5.

FIG. 7 provides a side view of the displacement compensator shown in FIG. 5.

FIG. 8 provides a perspective view of another illustrative displacement compensator.

FIG. 9 provides an illustration showing yet another illustrative displacement compensator.

FIG. 10 provides a flow diagram of an illustrative method for operating a system.

### DETAILED DESCRIPTION

As noted above, alignment-critical systems are subject to error in performance due to the movement of their optical components throughout their lifespan. The alignment-critical systems can include, but are not limited to, EO systems. This movement can come from several sources, for example: thermal changes growing/shrinking hardware, composites “drying out” (hygroscopic shrinkage), and/or material-related temporal growth. This movement is often compensated for via an electronically controlled motor and/or actuator that will move an optic to correct for focus and/or other optical error terms. The motor and/or actuator is often an expensive and complicated assembly that requires its own whole system of control to be designed, and introduces numerous additional points of failure in the design. Often, multiples of these expensive assemblies are used to ensure that there is redundancy in the alignment-critical system design. There are hundreds of components in a typical motor and/or actuator focus correction design approach.

While these alignment-critical system error sources are unavoidable, the alignment-critical system error sources may be compensated for passively. The present solution allows for the passive and/or active correction of short-term and/or long-term error contributors This may allow for a “launch and forget” approach, not requiring periodic focus adjustment or recalibration. Subsequently, there may be a more stable focus of the system, meaning the data coming back would be of more consistent quality and not subject to “good imaging” right after system calibration and “bad imaging” right before.

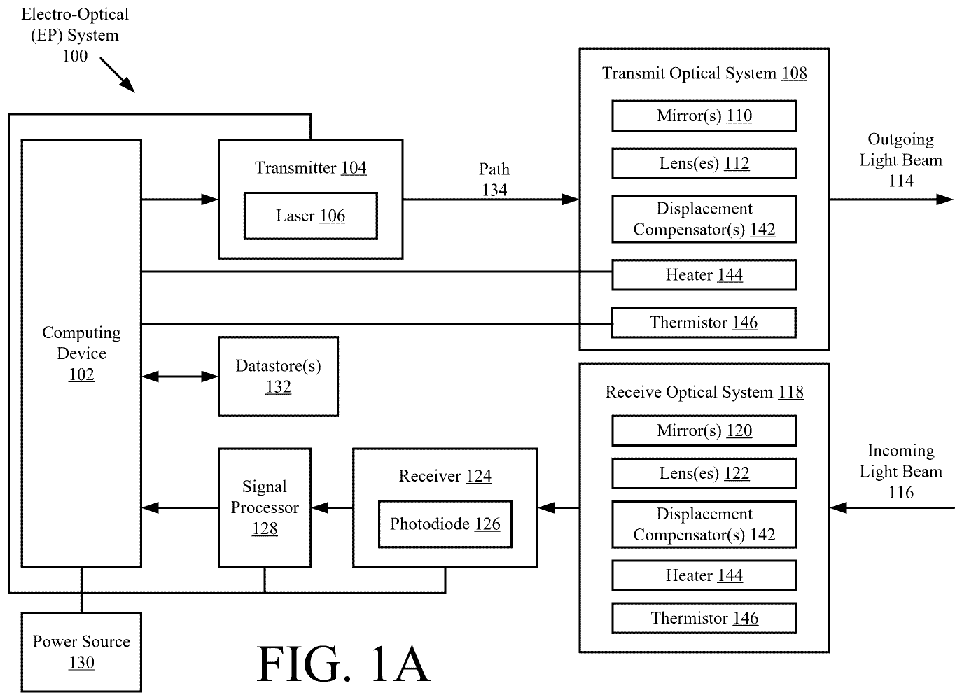

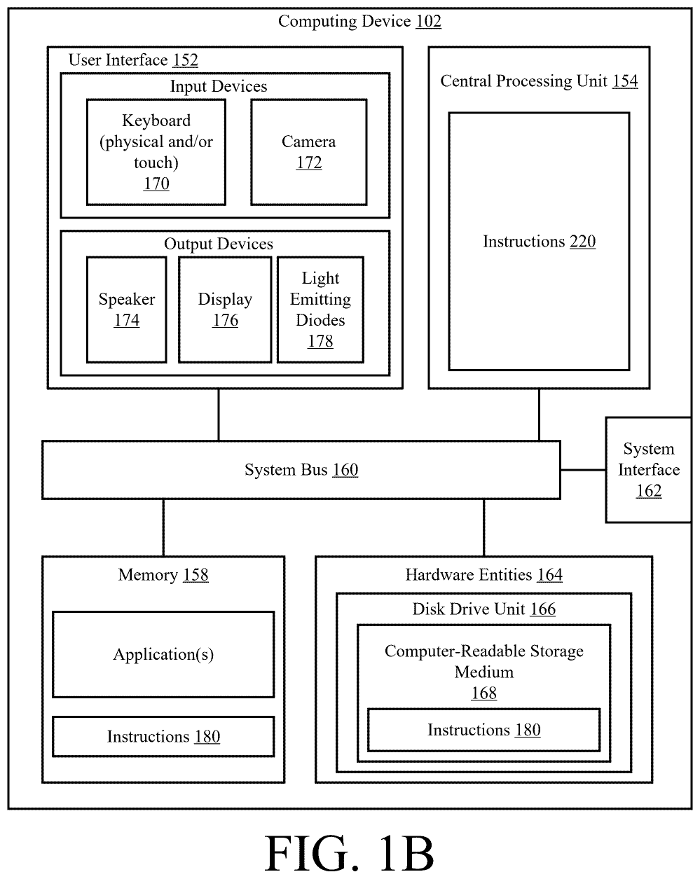

FIG. 1 provides an illustration of an alignment-critical system 100 implementing the present solution. The alignment-critical system 100 can include, but is not limited to, an EO system, a radio frequency (RF) system, a space based system, and/or a ground based system. The alignment-critical system will be described herein in terms of an EO system. However, the present solution is not limited in to such EO system implementations.

Alignment-critical system 100 is generally configured to emit light and/or receive light. Alignment-critical system 100 can include, but is not limited to, a telescope, an optical communication system, and/or a light detection and ranging (LiDAR) system.

Alignment-critical system 100 comprises more or less components than that shown in FIG. 1. For example, system 100 can comprise only a receive branch or alternatively both a transmit branch and a receive branch. System 100 will be discussed below in relation to the later scenario in which both transmit and receive branches are provided. Such a scenario can exist, for example, when alignment-critical system 100 comprises a LiDAR system that is configured to detect a distance therefrom to a target.

Alignment-critical system 100 comprises electronic components that may be powered by a power source 130. Power source 130 can include, but is not limited to, a battery and/or an energy harvesting based power supply. The electronic components can include, but are not limited to, a computing device 102, a transmitter 104, optical system(s) 108, 118, a receiver 124, and a signal processor 128. Computing device 102 is configured to control operations of alignment-critical system 100, and therefore is communicatively coupled to the other electronic components 104, 108, 118, 124, and/or 128. These operations can include, but are not limited to, generating commands, providing commands to other electronic components, transitioning motor(s) between ON state(s) and OFF state(s), causing optical signal(s) to be transmitted via transmitter 104 and optical system 108, causing signals received by receiver 124 to be processed by a signal processor 128 to obtain data, storing the data in a datastore(s) 132, and/or communicating data to external device(s) (not shown in FIG. 1).

During transmit operations of alignment-critical system 100, transmitter 104 provides a light source from which light is emitted. Any known or to be known light emitting transmitter or transmit circuit can be used in block 104. For example, transmitter 104 can include a laser 106. The emitted light travels along a path 134 to transmit optical system 108. Transmit optical system 108 comprises mirror(s) 110 and lens(es) 112 for collimating, focusing and/or re-directing the light to form an outgoing light beam 114. Any known or to be known mirror(s), lens(es), and/or mirror-lens arrangements can be used here.

During receive operations of alignment-critical system 100, a receive optical system 118 is configured to receive an incoming light beam 116. The receive optical system 118 comprises mirror(s) 110 and lens(es) 112 for collecting, re-directing and/or focusing the light onto a photodiode 126 of receiver 124. Any known or to be known mirror(s), lens(es), and/or mirror-lens arrangements can be used here. The photodiode 126 produces an electrical current as it absorbs photons when exposed to light. The electrical current is passed to signal processor 128. Signal processor 128 can analyze the electrical current to obtain data associated with observed objects and/or data communicated via optical signals.

Alignment-critical system 100 may optionally comprise heater(s) 144 and/or thermistor(s) 146 to facilitate the displacement compensator(s) operations described herein. For example, the heater 144 can be used to heat an internal environment of the alignment-critical system 100 and/or a material of the displacement compensator. The thermistor(s) 146 can be used to monitor a temperature of the internal environment and/or a temperature of the material of the displacement compensator. The material can include the same or different material as the support structure supporting optical components of the optical system(s).

FIG. 1B provides a more detailed block diagram of computing device 102.

Computing device 102 may include more or less components than those shown in FIG. 1B. However, the components shown are sufficient to disclose an illustrative solution implementing the present solution. The hardware architecture of FIG. 1B represents one implementation of a representative computing device configured to provide an improved in-field radio configuration process, as described herein. As such, the computing device 102 of FIG. 1 implements at least a portion of the method(s) described herein.

Some or all components of the computing device 102 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

Computing device 102 comprises a user interface 152, a central processing unit (CPU) 154, a system bus 156, a memory 158 connected to and accessible by other portions of computing device 102 through system bus 160, a system interface 162, and hardware entities 164 connected to system bus 160. The user interface can include input devices and output devices, which facilitate user-software interactions for controlling operations of the computing device 102. The input devices may include, but are not limited, a physical and/or touch keyboard 170, a camera 172, a mouse, and/or a microphone. The input devices can be connected to the computing device 102 via a wired or wireless connection (e.g., a Bluetooth® connection). The output devices include, but are not limited to, a speaker 174, a display 176, and/or light emitting diodes 178. System interface 162 is configured to facilitate wired or wireless communications to and from external devices (e.g., network nodes such as access points, databases, etc.).

At least some of the hardware entities 164 perform actions involving access to and use of memory 158, which can be a RAM. Hardware entities 164 can include a disk drive unit 166 comprising a computer-readable storage medium 168 on which is stored one or more sets of instructions 180 (e.g., software code) configured to implement one or more of the methodologies, procedures, or functions described herein. The instructions 180 can also reside, completely or at least partially, within the memory 158 and/or within the CPU 154 during execution thereof by the computing device 102. The memory 158 and the CPU 154 also can constitute machine-readable media. The term “machine-readable media”, as used here, refers to a single medium or multiple media (e.g., a centralized or distributed database, and/or associated caches and servers) that store the one or more sets of instructions 180. The term “machine-readable media”, as used here, also refers to any medium that is capable of storing, encoding or carrying a set of instructions 180 for execution by the computing device 102 and that cause the computing device 102 to perform any one or more of the methodologies of the present disclosure.

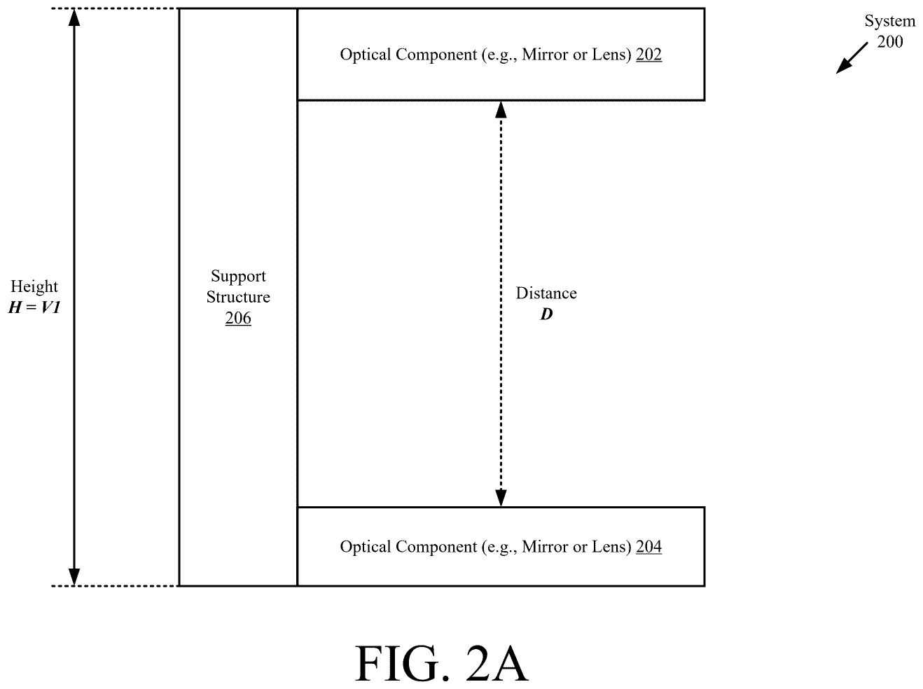

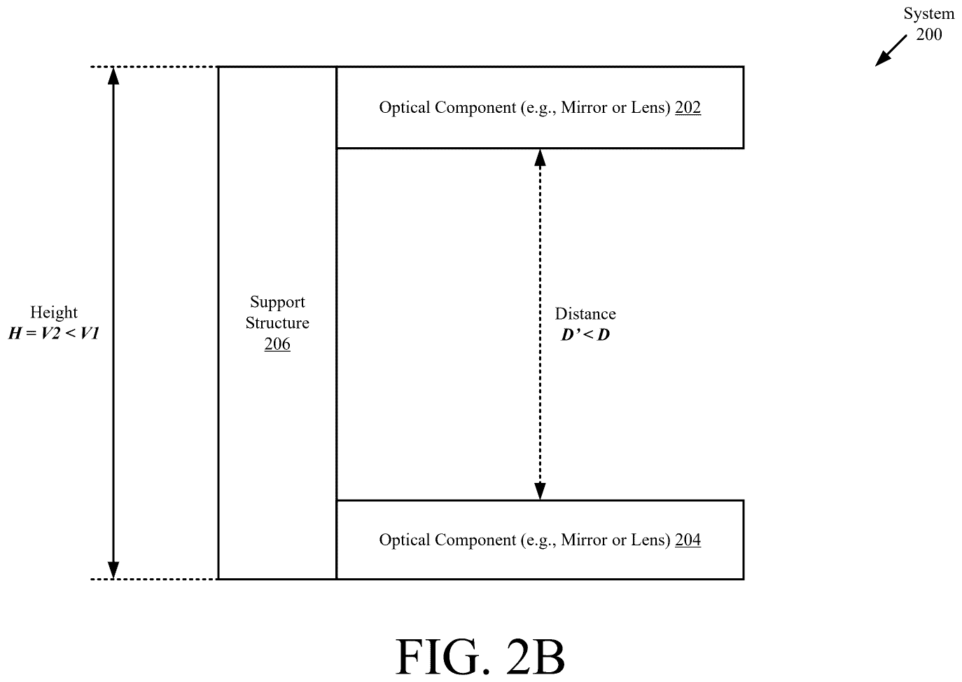

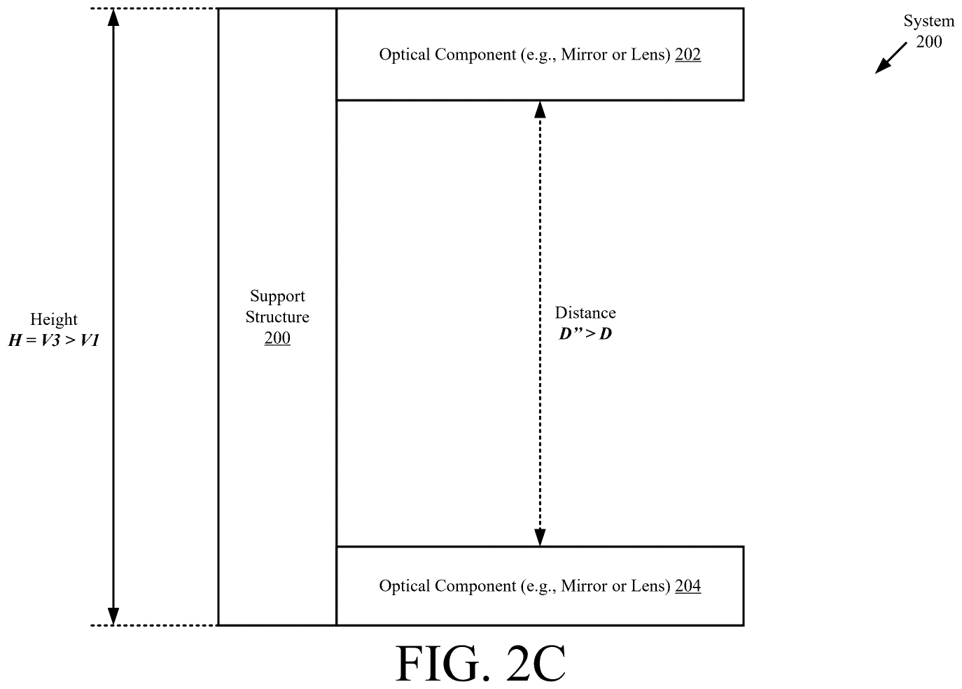

FIG. 2 shows an illustrative architecture for an optical system 200. Optical system 200 comprises two optical components 202, 204 which are structurally supported by a support structure 206. Support structure 206 may be formed of any material, for example, polymer(S), metal(s), and/or composite material(s). The support structure 206 is configured to hold the optical components in a spaced apart relationship. In this way, the optical components 202, 204 are spaced apart by a distance D. The support structure 206 may experience dimensional changes resulting from numerous sources, for example: thermal changes, hygroscopic shrinkage (e.g., dry out caused by loss of water or moisture in material), hygroscopic swelling (e.g., absorption or adsorption of water from a surrounding environment), and/or material-related temporal growth. As such, the distance D may change during the lifetime of the optical system 200 as a result of changes in one or more geometric dimensions (e.g., height H) of the support structure 206.

For example, as shown in FIG. 2B, the height H of support structure 206 changes from a first value V1 to a second smaller value V2. Accordingly, distance D also decreases to D′. The height H of support structure 206 may additionally or alternatively increase to a third value V1 as shown in FIG. 2C. In this case, distance D increases to D″. This variation in distance D may cause misalignments between the mirror(s) and/or lens(es) resulting in performance issues with the optical system 200.

The present solution provides a novel solution to compensate for changes in the overall size of the support structure and/or other parts of the optical system which may have an optical effect. The novel solution employes one or more displacement compensator(s) 142 to compensate for changes in material geometry resulting from numerous sources, for example: changes in one or more characteristics of a surrounding environment (e.g., temperature changes), hygroscopic shrinkage, hygroscopic swelling, and/or material-related temporal growth.

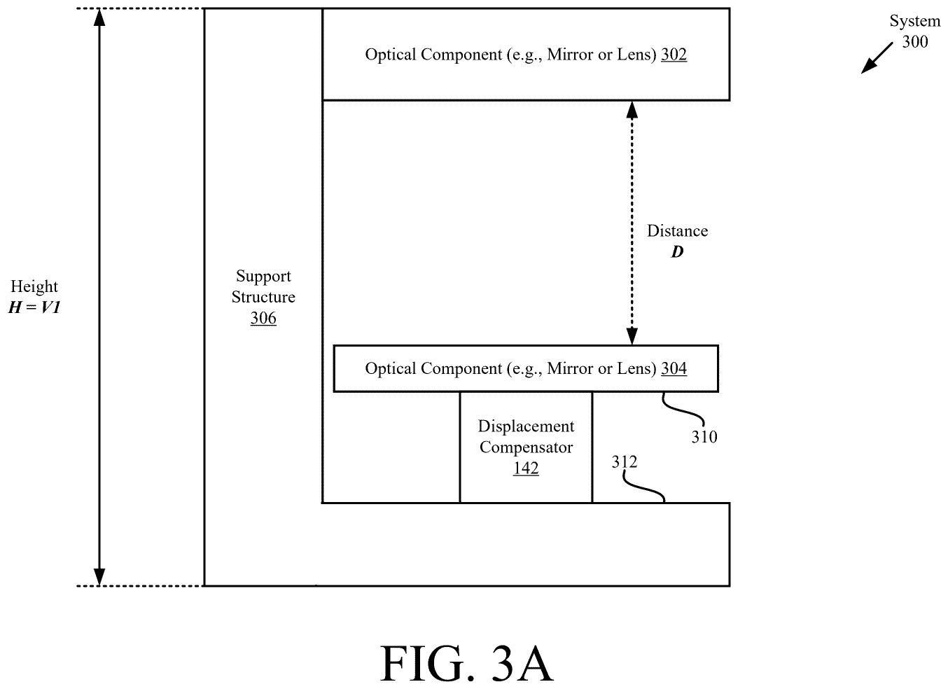

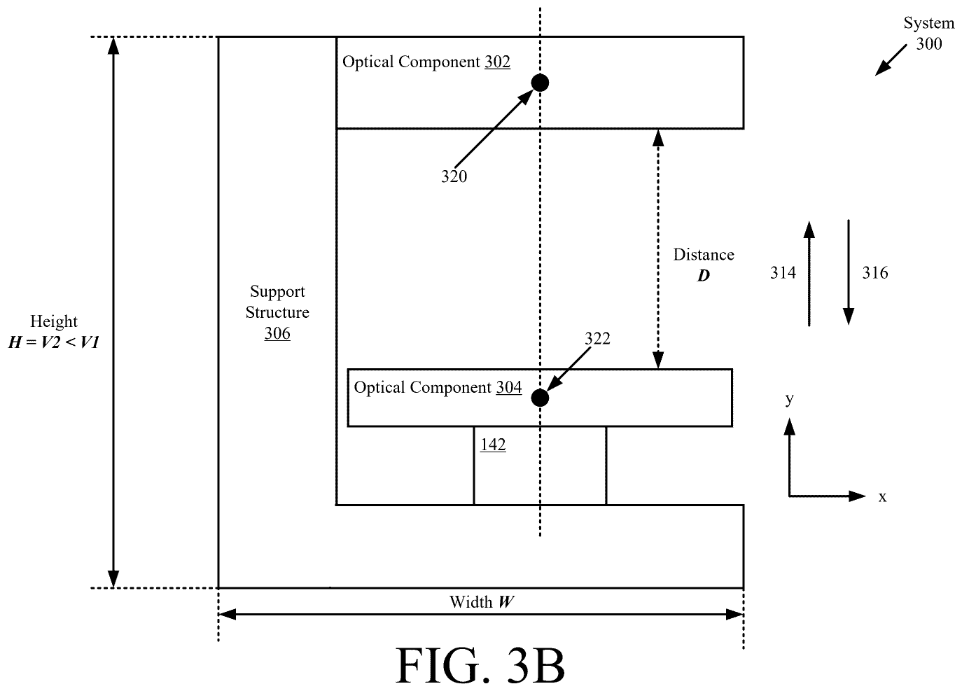

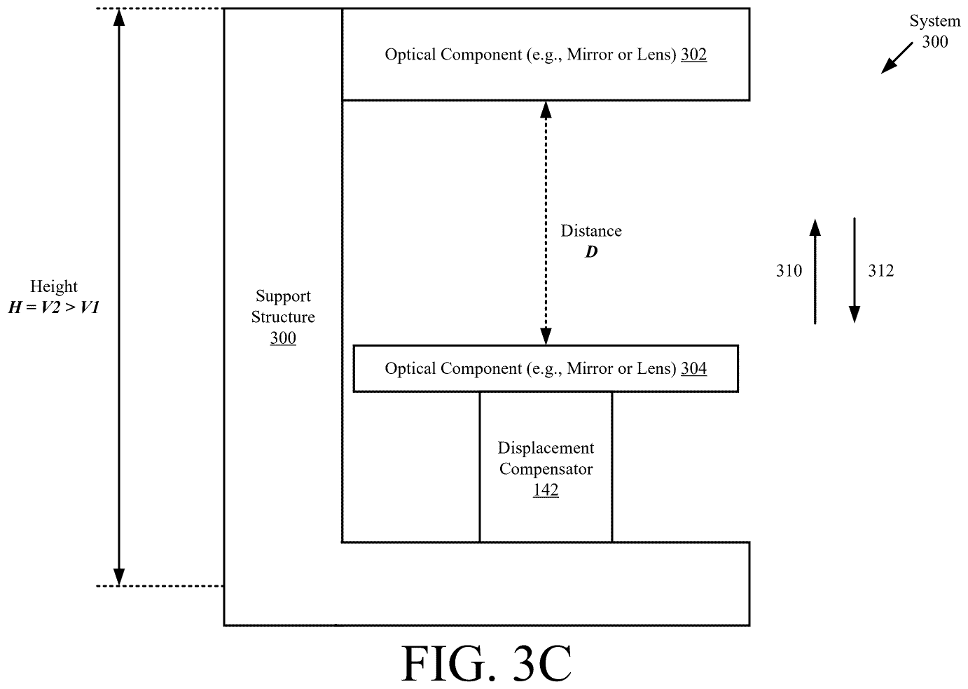

FIG. 3 shows an illustrative architecture for an optical system 300. Optical system 108 and/or 118 of FIG. 1 may have the same or similar architecture as optical system 300. Thus, the discussion of optical system 300 is sufficient for understanding optical systems 108 and 118 of FIG. 1. Optical system 300 comprises at least two optical components 302, 304 which are structurally supported by a support structure 306. Optical components 302 and 304 can include, but are not limited to, mirror(s) 110 of FIG. 1, mirror(s) 120 of FIG. 1, lens(es) 112 of FIG. 1, lens(es) 122 of FIG. 1, optical sensors, and/or transmitters.

Support structure 306 may be formed of any material, for example, polymer(s), metal(s), and/or composite material(s). The support structure 306 is configured to hold or otherwise maintain the optical components in a spaced apart relationship. In this way, the optical components 302, 304 are spaced apart by a distance D. The support structure 306 may experience changes in material geometry resulting from numerous sources, for example: thermal changes, hygroscopic shrinkage, hygroscopic swelling, and/or material-related temporal growth. As such, a displacement compensator 142 is configured to ensure that (i) the distance D along at least one axis (e.g., the y-axis, x-axis and/or x-axis) does not change between the optical components 302, 304 during the lifespan of the optical system 200, (ii) centers of the optical components 302, 304 remain aligned relative to at least one axis (e.g., the y-axis, x-axis and/or x-axis) during the lifespan of the optical system 200, and/or (iii) the tip/tilt/rotation does not change between the optical components 302, 304 during the lifespan of the optical system 200, despite any changes in one or more geometric dimensions (e.g., height H, width W and/or length) of the support structure 206.

As shown in FIG. 3B, the height H of support structure 306 may change from a first value V1 to a second smaller value V2. Despite this reduction in the support structure's height, the distance D between optical components 302 and 304 remains the same as a result of the displacement compensator 142. Similarly, as shown in FIG. 3C, the distance D between optical components 302 and 304 remains the same when the structural support's height increases, as a result of the displacement compensator 142. In this way, the centers 320, 322 of the optical components 302, 304 have constant (e.g., the same or within a given tolerance range) y-axis values. For example, center 320 of optical component 302 has a constant y-axis value of ten, and center 322 of optical component 304 has a constant y-axis value of one. The present solution is not limited to the particular of this example.

Additionally or alternatively, the displacement compensator 142 may be configured to maintain alignment of the centers 320, 322 of the optical components 302, 304 such that the centers have the same value on the x-axis and/or the z-axis regardless of any variation or change in the support structures width W and/or length L.

In the scenario of FIG. 3, the displacement compensator 142 is disposed between the lower or bottom optical component 304 and the support structure 306. The displacement compensator 142 is generally configured to: apply a pulling force in direction 316 to optical component 304 and a pulling force in direction 314 to support structure 306 when the support structure's height H decreases as shown in FIG. 3B; and apply a pushing force in direction 314 on optical component 304 and a pushing force in direction 316 on support structure 306 when the support structure's height H increases as shown in FIG. 3C. The pulling forces of FIG. 3B cause the optical component 304 to be moved in direction 316 towards to the support structure 306 and away from the other optical component 302. The pushing forces of FIG. 3C cause the optical component 304 to be moved in direction 314 away from the support structure 306 and towards the other optical component 302. In this way, the distance D remains constant or within a given tolerance range despite variations in the physical geometry of the support structure 306.

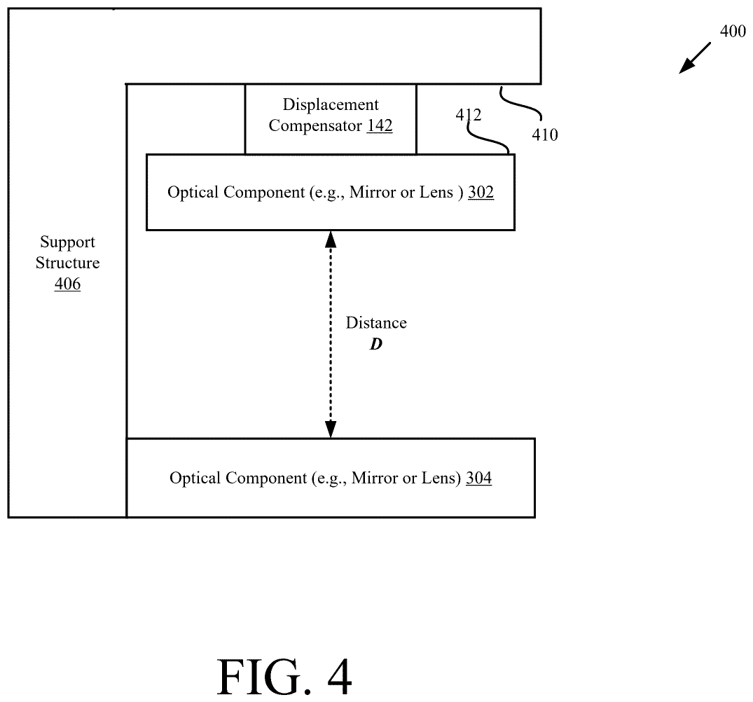

The present solution is not limited to the architecture shown in FIG. 3. Alternatively, the displacement compensator 142 can be disposed between the upper or top optical component 302 and a support structure, as shown in FIG. 4.

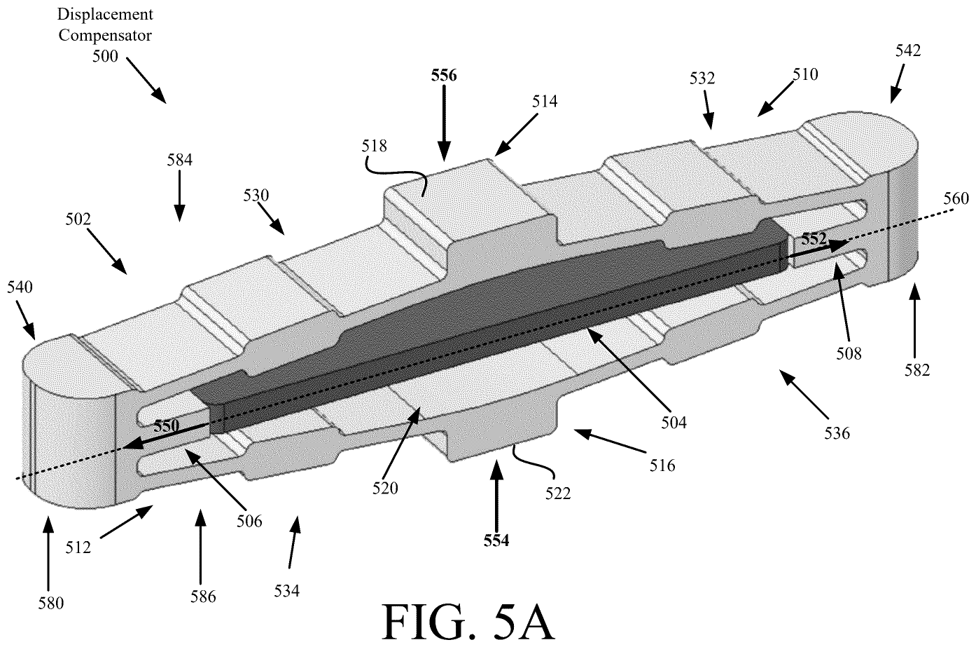

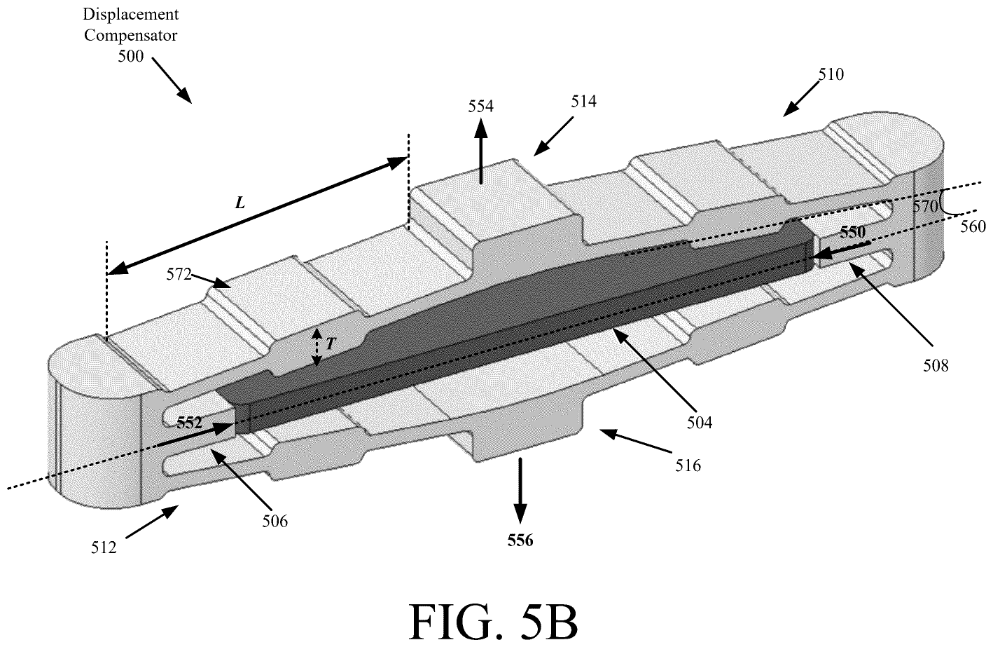

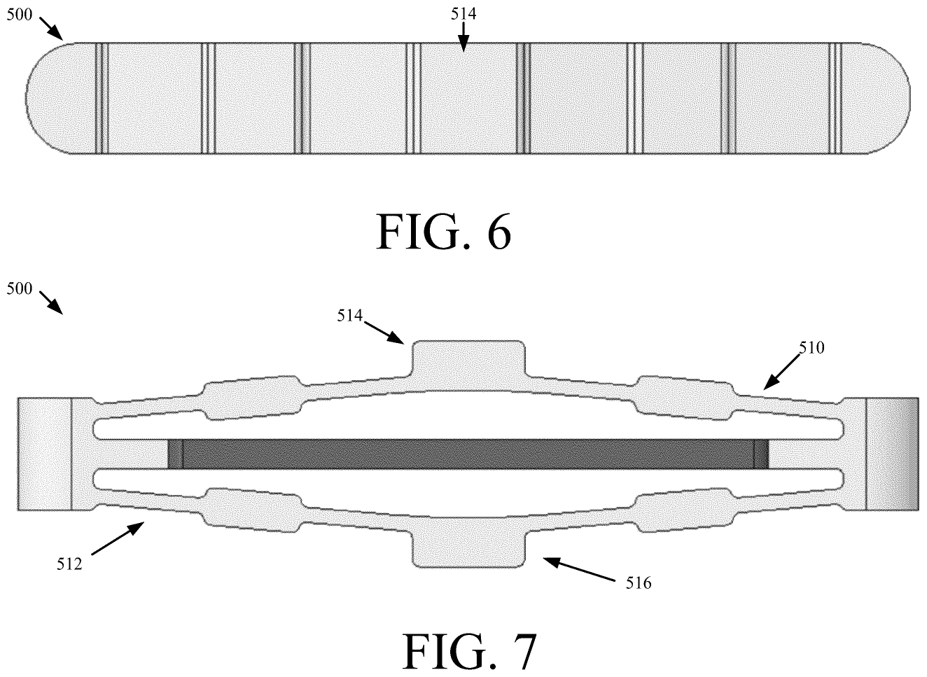

An illustrative architecture for a displacement compensator 500 is shown in FIGS. 5-7. Displacement compensator 142 can be the same as or similar to displacement compensator 500. Thus, the discussion of displacement compensator 500 is sufficient for understanding displacement compensator(s) 142 of FIGS. 1, 3 and 4.

Displacement compensator 500 comprises a body 502 in which a material sample 504 is disposed. Body 502 is formed of any material selected in accordance with a particular application. Body 502 may include, but is not limited to, titanium and/or other flexible material with a particular ratio of material yield strength to material modulus of elasticity. So, the body 502 may comprise a relatively high strength material with a relatively low modulus of elasticity. Body 502 may comprise a single piece or multiple pieces that are machined, molded, 3D printed, or otherwise manufactured. Body 502 is designed in such a manner that displacements of material sample 504 that push or pull on inward protruding members 506, 508 along axis 560 may get amplified when displacing protruding portions 514, 516.

The material sample 504 comprises a same material as the support structure (e.g., support structure 306 of FIG. 3) that is structurally supporting optical components (e.g., optical components 302 and 304 of FIG. 3) in relative positions. In this regard, material sample 504 can include, but is not limited to, polymer(s), metal(s), and/or composite material(s). Accordingly, the rate of change of geometric dimensions of the material sample 504 and the structural support (e.g., structural support 306 of FIG. 3 or 406 of FIG. 4) may be the same due, for example: temperature variations, hygroscopic shrinkage, hygroscopic swelling, and/or material-related temporal growth.

The size and/or shape of the material sample 504 is selected in accordance with a particular application, and is related to the amplification provided by body 502. The size and/or shape of sample 504 may be selected to provide or facilitate a linear relationship between the amount of change (positive or negative) of the support structure's geometric dimension (e.g., height H) and the amount of position displacement of the optical component (e.g., optical component 302 of FIG. 3) by the displacement compensator 500 relative to an adjacent surface (e.g., surface 312 of FIG. 3) of the support structure (e.g., support structure 306 of FIG. 3). For example, the material sample 504 is sized to provide a 0.010 inch dimension change to compensate for or negate 0.100 inches of dimension change of the structural support, through use of a body 502 designed to provide a ten-times displacement amplification. Thus, during the lifespan, the displacement compensator 500 causes the optical component to move away from the adjacent surface of the support structure by 0.100 inches when the height H of the support structure increases by 0.100 inches, and causes the optical component to move towards the adjacent surface of the support structure by 0.100 inches when the height H of the support structure decreases by 0.100 inches. The present solution is not limited to the particulars of this example. In this way, the distance D between the two optical components remains constant or within a range of distances from each other despite the structural support's dimension changes.

The material sample 504 is structurally supported by inward protruding members 506, 508 so as to be suspended within a center internal hollow space 520 of the displacement compensator 500. As shown in FIG. 5A, the material sample 504 may expand in directions 550 and 552 along axis 560. When this occurs, the material sample 504 applies a pushing force on the inward protruding members 506, 508 such that the inward protruding members 506, 508 move away from each other along a center axis 560 of the body 502. In effect, the engagement members 510 and 512 are both caused to bend toward the center axis 560, whereby a center protruding portion 514 of engagement member 510 moves in direction 556 and a center protruding portion 516 of engagement member 512 moves in opposite direction 554 such that the two center protruding portions 514, 516 move toward from each other.

In contrast, as shown in FIG. 5B, the material sample 504 may shrink or otherwise contracts in directions 550 and 552 along axis 560. Accordingly, the material sample 504 applies a pulling force on the inward protruding members 506, 508 such that the inward protruding members 506, 508 move toward each other along a center elongate axis 560 of the body 502. When this occurs, the engagement members 510 and 512 are caused to bend away from the center axis 560, whereby the center protruding portion 514 moves in direction 554 and the center protruding portion 516 move in direction 556 such that the two center protruding portions 514, 516 move away from each other.

Each center protruding portion 514, 516 has a flat or planar engagement surface 518, 522 for engaging with a surface of an external adjacent object. For example, during the lifespan of the displacement compensator 500, surface 518 of center protruding portion 514 is in contact with and/or coupled to a surface (e.g., surface 310 of FIG. 3 or 410 of FIG. 4) of an adjacent object (e.g., optical component 304 of FIG. 3 or support structure 406 of FIG. 4). Surface 522 of center protruding portion 516 is in contact with and/or coupled to a surface (e.g., surface 312 of FIG. 3 or 412 of FIG. 4) of an adjacent object (e.g., support structure 306 of FIG. 3 or optical component 302 of FIG. 4). The coupling of surfaces 518 and 522 to an external object can be achieved using, for example, an adhesive (not shown in FIGS. 5-7). Any known or to be known adhesive can be used here. As a result of the coupling, the displacement compensator 500 pushes the two external objects away from each other when the material sample 504 shrinks or otherwise contracts, and pulls the two external objects toward each other when the material sample 504 expands.

Each engagement member 510, 512 has flexures 530, 532, 534, 536 connected between the center protruding portion 514, 516 and respective ends 540, 542 of the body 502. Each flexure is configured to facilitate movement of the respective center protruding portion 514, 516 in directions 554, 556 passively in response to changes in geometric dimensions of sample material 504. Each flexure is shown as comprising a varying thickness T along its elongate length L. The present solution is not limited in this regard. Each flexure can alternatively have a constant thickness along its elongate length L. However, the center thicker portion 572 of the flexure provides a higher buckling strength (with minimal effect on flexure rigidity) so that the flexure does not break when a given range of forces are applied thereto.

The angle 570 of each flexure relative to the center axis 560 is one of several factors that define the amplification factor. The angle 570 may have a value between N degrees and M degrees, wherein each of N and M is an integer between negative ninety and ninety. M is greater than N.

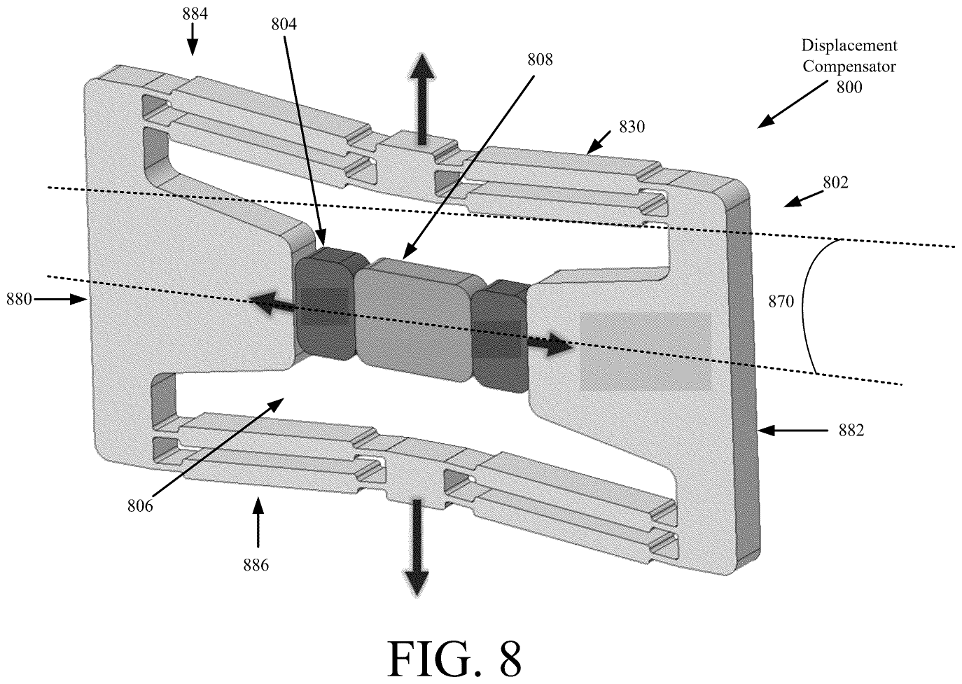

The displacement compensator is not limited to the architecture shown in FIG. 5-7. Another architecture for a displacement compensator 800 is shown in FIG. 8. Displacement compensator 142 of FIGS. 1 and 3 can be the same as or similar to displacement compensator 800.

Displacement compensator 800 is configured to operate in manner similar to displacement compensator 500. However, there are differences between the two displacement compensators. For example, eight flexures 830 are provide in FIG. 8 rather than four flexures 530, 532, 534, 536 as shown in FIG. 5. The displacement compensator can have any number of flexures selected in accordance with a given application. Thus, the present solution is not limited to the number of flexures shown in FIGS. 5-8.

As also shown in FIG. 8, another body 804 is disposed in the hollow center space 806 along with the material sample 808. The material of body 804 is selected such that it has a coefficient of thermal expansion (CTE) suitable to compensate for thermal-related error terms that arise in the optical system. Body 804 may be provided in addition to the material sample 808 to facilitate compensation of the effects of thermal growth to the optical system. In addition to, or in place of, passive body 804, a piezoelectric material may be provided for active control of the system, the piezoelectric component having its own system of electronics for control.

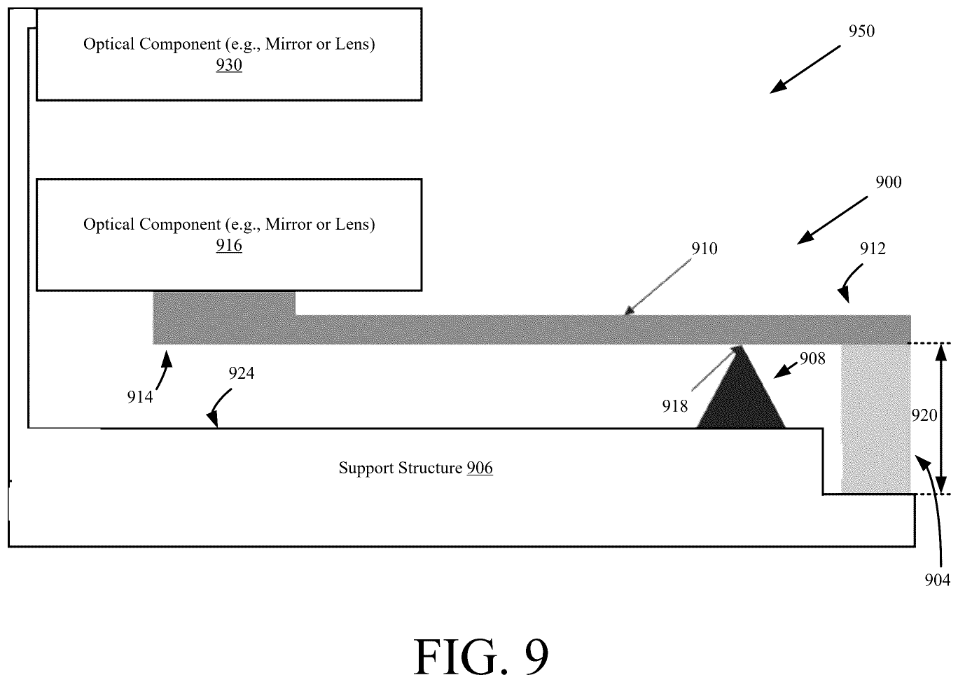

Yet another architecture for a displacement compensator 900 is shown in FIG. 9. Displacement compensator 142 of FIGS. 1 and 3 can be the same as or similar to displacement compensator 900. Displacement compensator 900 comprises a material sample 904 and a pivot member 908 which are disposed on the support structure 906. A rigid lever arm 910 is coupled at a proximal end 912 to the material sample 904 and is coupled at a distal end 914 to an optical component 916. The rigid lever arm 910 pivots on a pivot point 918 of the pivot member 908 passively due to changes in a geometric dimension 920 of the material sample 904. In this way, the displacement compensator 900 moves the optical component 916 closer to and farther from an adjacent surface 924 of the support structure 906 when the geometric dimensions(s) of the support structure 906 change resulting from numerous sources, for example: temperature, hygroscopic shrinkage, hygroscopic swelling, and material-related temporal growth. Displacement compensator 900 achieves mechanical amplification of the displacement of the material sample 904 through the placement of pivot point 918 along the length of rigid lever arm 910.

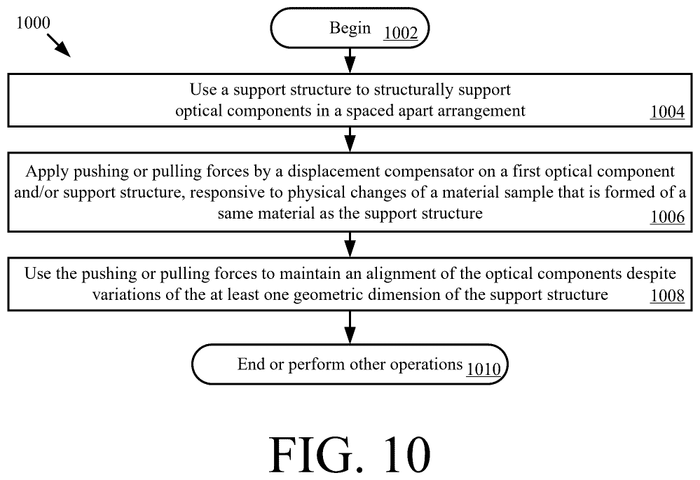

FIG. 10 provides a flow diagram of an illustrative method 1000 for operating an alignment-critical system (e.g., optical system 108 of FIG. 1, 118 of FIG. 1, 300 of FIG. 3, 400 of FIG. 4, or 950 of FIG. 9). Method 1000 begins with 1002 and continues with 1004 where a support structure (e.g., support structure 306, 406, or 906) is used to structurally support at least two optical components (e.g., optical components 110, 112, 120, 122, 302, 304, 916 and/or 930) in a spaced apart arrangement. The support structure comprises a material having at least one geometric dimension that varies throughout the lifespan of the alignment-critical system. The geometric dimension can include, but is not limited to, a height, a length, a width, and/or a thickness.

Next in 1006, a displacement compensator (e.g., displacement compensator 142, 500, 800 or 900) applies pushing forces or pulling forces on at least one optical component of the at least two optical components and/or the support structure, responsive to physical changes of a material sample (e.g., material sample 504, 808 or 904) of the displacement compensator. The material sample is formed of a same material as the support structure.

The displacement compensator may be disposed between the support structure and a first optical component. In some scenarios, the displacement compensator may comprise a body (e.g., body 502, 802) defined by a plurality of sidewalls (e.g., sidewalls 580, 582, 584, 586 of FIG. 5 or 880, 882, 884, 886 of FIG. 8) extending around a hollow center space (e.g., hollow space 520 or 806) in which the material sample is suspended by opposing first and second sidewalls (e.g., sidewalls 580, 582 or 880, 882) of the plurality of sidewalls. In this case, block 1006 may comprise: applying by the material sample pushing forces in opposing first outward directions to the first and second sidewalls when the material sample expands in size; or applying by the material sample pulling forces in opposing first inward directions to the first and second sidewalls when the material sample shrinks in size. It should be noted that the directionality is dependent on the design. If angle 570 is negative, the directionality is opposite of what it would be if angle 570 were positive. FIGS. 5-7 show a positive angle 570, while FIG. 8 shows a negative angle 870. The first and second sidewalls may cause third and fourth sidewalls of the plurality of sidewalls to bend in opposing second inward directions when the pushing forces are being applied to the first and second sidewalls. The second inward directions being perpendicular to the first outward directions. The first and second sidewalls may cause third and fourth sidewalls of the plurality of sidewalls to bend in opposing second outward directions when the pulling forces are being applied to the first and second sidewalls. The second outward directions being perpendicular to the first inward directions. The bending of the third and fourth sidewalls facilitates the application of the pushing or pulling forces by the displacement compensator on the first optical component and/or the support structure.

The pushing forces or pulling forces are used 1008 to maintain an alignment of the at least two optical components despite variations of the at least one geometric dimension of the support structure. The alignment of the optical components may be maintained, for example, by keeping a distance between the at least two optical components constant or within a given tolerance range of values. The pushing forces may be applied by the displacement compensator to push the first optical component away from an adjacent surface (e.g., surface 312, 410 or 924) of the support structure when the geometric dimension(s) of the support structure increase(s). The pulling forces may be applied by the displacement compensator to pull the first optical component towards the adjacent surface of the support structure when the geometric dimension(s) of the support structure decrease(s). Upon completing 1008, method 1000 continues with 1010 where it ends or other operations are performed.

As evident from the above discussion, the present solution concerns an alignment-critical system (e.g., optical system 108 of FIG. 1, 118 of FIG. 1, 300 of FIG. 3, 400 of FIG. 4, or 950 of FIG. 9) with a novel design. The alignment-critical system comprises: at least two optical components (e.g., optical components 110, 112, 120, 122, 302, 304, 916 and/or 930); and a support structure (e.g., support structure 306, 406, or 906) configured to structurally support the optical components in a spaced apart arrangement. The support structure comprises a material having at least one geometric dimension (e.g., length, width and/or height) that varies throughout the lifespan of the alignment-critical system. The variation in the geometric dimension(s) of the support structure may be due to several sources, for example: temperature change, hygroscopic shrinkage, hygroscopic swelling, and material-related temporal growth.

A displacement compensator (e.g., displacement compensator 142, 500, 800 or 900) is disposed between the support structure and a first optical component (e.g., optical component 302, 304, or 916) of the optical components. The displacement compensator is configured to passively mechanically maintain an alignment of the optical components, despite variations of the geometric dimension(s) of the support structure. The alignment of optical components may be maintained, for example, by keeping a distance (e.g., distance D) between the optical components constant or within a tolerance range. In this regard, the displacement compensator is configured to apply pushing forces or pulling forces on the first optical component responsive to physical changes of a material sample (e.g., material sample 504, 808 or 920) formed of the same material as the support structure. The physical change can include, but is not limited to, a change in an overall size of the material sample or a change in one or more geometric dimensions (e.g., length, width and/or height) of the material sample.

In some scenarios, the displacement compensator comprises a body (e.g., body 502, 802) having a hollow center space (e.g., hollow space 520 or 806) in which the material sample is suspended. Another material (e.g., material 804) may be disposed in the hollow center space so as to reside between the sample material and the body of the displacement compensator. The another material may have a CTE different than a CTE of the sample material and/or may be a piezoelectric material with its own system of electronic control.

The material sample may be sized and shaped to facilitate a relationship between an amount of change of the support structure's geometric dimension(s) and an amount of position displacement of the first optical component by the displacement compensator relative to an adjacent surface (e.g., surface 312, 410 or 924) of the support structure. The displacement compensator may be configured to push the first optical component away from the adjacent surface of the support structure when the geometric dimension(s) of the support structure increase(s), and pull the first optical component towards the adjacent surface of the support structure when the geometric dimension(s) of the support structure decrease(s).

The body may comprise a single continuous piece extending around the hollow center space and being defined by a plurality of sidewalls (e.g., sidewalls 580, 582, 584, 586 of FIG. 5 or 880, 882, 884, 886 of FIG. 8). The material sample is suspended with the hollow center space by opposing first and second sidewalls (e.g., sidewalls 580, 582 or 880, 882) of the plurality of sidewalls. The material sample is configured to (i) apply pushing forces in opposing first outward directions to the first and second sidewalls when the material sample expands in size, and (ii) applies pulling forces in opposing first inward directions to the first and second sidewalls when the material sample shrinks in size.

The first and second sidewalls may cause third and fourth sidewalls (e.g., sidewalls 584, 586 or 884, 886) of the plurality of sidewalls to bend in opposing second inward or outward directions when the pushing or pulling forces are being applied to the first and second sidewalls. The second inward or outward directions are perpendicular to the first outward directions. The third sidewall may be coupled to one of the at least two optical components and the fourth sidewall may be coupled to the support structure.

In other scenarios, the displacement compensator comprises a rigid lever (e.g., lever 910 of FIG. 9) configured to pivot about a pivot point (e.g., pivot point 918 of FIG. 9) passively in response to the physical changes of the material sample (e.g., sample 904 of FIG. 9). A first end (e.g., end 912 of FIG. 9) of the rigid lever is coupled to the material sample and an opposing second end (e.g., end 914 of FIG. 9) of the rigid lever is coupled to the first optical component.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

What is claimed is:

1. A system, comprising:
at least two optical components;
a support structure configured to structurally support the at least two optical components in a spaced apart arrangement, the support structure comprising a material having at least one geometric dimension that varies throughout a lifespan of the system; and
a displacement compensator disposed between the support structure and a first optical component of the at least two optical components, and configured to passively and mechanically maintain an alignment of the at least two optical components, despite variations of the at least one geometric dimension of the support structure;
wherein the displacement compensator is configured to apply pushing forces or pulling forces on the first optical component responsive to physical changes of a material sample formed of a same material as the support structure.

2. The system according to claim 1, wherein the alignment of the at least two optical components is maintained by keeping a distance between the at least two optical components constant.

3. The system according to claim 1, wherein the at least one geometric dimension of the support structure varies due to a multitude of sources comprising a temperature change, hygroscopic shrinkage, hygroscopic swelling, and or material-related temporal growth.

4. The system according to claim 1, wherein the material sample is sized and shaped to facilitate a relationship between an amount of change of the at least one geometric dimension and an amount of position displacement of the first optical component by the displacement compensator relative to an adjacent surface of the support structure.

5. The system according to claim 1, wherein the displacement compensator comprises a body having a hollow center space in which the material sample is suspended.

6. The system according to claim 5, wherein another material is disposed in the hollow center space so as to reside between the sample material and the body of the displacement compensator, the another material having a coefficient of thermal expansion different than a coefficient of thermal expansion of the sample material.

7. The system according to claim 5, wherein the body of the displacement compensator comprises a single continuous piece extending around the hollow center space and being defined by a plurality of sidewalls.

8. The system according to claim 7, wherein the material sample is suspended with the hollow center space by opposing first and second sidewalls of the plurality of sidewalls.

9. The system according to claim 8, wherein the material sample (i) applies pushing forces in opposing first outward directions to the first and second sidewalls when the material sample expands in size, and (ii) applies pulling forces in opposing first inward directions to the first and second sidewalls when the material sample shrinks in size.

10. The system according to claim 9, wherein the first and second sidewalls cause third and fourth sidewalls of the plurality of sidewalls to bend in opposing second inward or outward directions when the pushing or pulling forces are being applied to the first and second sidewalls, the second inward or outward directions being perpendicular to the first directions.

11. The system according to claim 10, wherein the third sidewall is coupled to one of the at least two optical components and the fourth sidewall is coupled to the support structure.

12. The system according to claim 1, wherein the displacement compensator comprises a rigid lever configured to pivot about a pivot point passively in response to the physical changes of the material sample.

13. The system according to claim 12, wherein a first end of the rigid lever is coupled to the material sample and an opposing second end of the rigid lever is coupled to the first optical component.

14. A method for operating a system, comprising:
using a support structure to structurally support at least two optical components in a spaced apart arrangement, wherein the support structure comprises a material having at least one geometric dimension that varies throughout a lifespan of the system;
applying pushing forces or pulling forces by a displacement compensator on a first optical component of the at least two optical components responsive to physical changes of a material sample of the displacement compensator that is formed of a same material as the support structure; and
using the pushing forces or pulling forces to maintain an alignment of the at least two optical components despite variations of the at least one geometric dimension of the support structure;
wherein the displacement compensator is disposed between the support structure and a first optical component of the at least two optical component.

15. The method according to claim 14, wherein the alignment of the at least two optical components is maintained by keeping a distance between the at least two optical components constant.

16. The method according to claim 14, wherein the pushing forces are applied by the displacement compensator to push the first optical component away from an adjacent surface of the support structure when the at least one geometric dimension of the support structure increases, and the pulling forces are applied by the displacement compensator to pull the first optical component towards the adjacent surface of the support structure when the at least one geometric dimension of the support structure decreases.

17. The method according to claim 14, wherein the displacement compensator comprises a body defined by a plurality of sidewalls extending around a hollow center space in which the material sample is suspended by opposing first and second sidewalls of the plurality of sidewalls.

18. The system according to claim 17, further comprising:
applying by the material sample pushing forces in opposing first outward directions to the first and second sidewalls when the material sample expands in size; or
applying by the material sample pulling forces in opposing first inward directions to the first and second sidewalls when the material sample shrinks in size;
wherein the first and second sidewalls cause third and fourth sidewalls of the plurality of sidewalls to bend in opposing second inward or outward directions when the pushing or pulling forces are being applied to the first and second sidewalls, the second directions being perpendicular to the first directions.
